(19) United States
(12) Patent Application Publication
(10) Pub. No.: US 2013/0040125 A1
(43) Pub. Date: Feb. 14, 2013

(54) EXPANDABLE POLYMERS OF CELLULOSE ACETATE BUTYRATE

(71) Applicants: Roman Eberstaller, Obergrafendorf (AT); Gerhard Hintermeier, St. Polten (AT)

(72) Inventors: Roman Eberstaller, Obergrafendorf (AT); Gerhard Hintermeier, St. Polten (AT)

(73) Assignee: SUNPOR Kunstrsoff Ges. m.b.H. a corporation

(21) Appl. No.: 13/520,133

(22) PCT Filed: Dec. 30, 2010
(86) PCT No.: PCT/AT2010/000497

§ 371 Date: Oct. 25, 2012

(30) Foreign Application Priority Data
Dec. 30, 2009 (AT) A2054/2009

(51) Int. Cl. C09D 101/02; B32B 5/18; B32B 9/04; C08B 3/18; B32B 23/12

(52) U.S. Cl. 428/221; 536/65; 106/122; 428/407; 428/404

(57) ABSTRACT

The invention relates to expandable polymers and/or polymer granulates of cellulose acetate butyrate (CAB) having an average molecular weight (Mn), determined as polystyrene-equivalent molecular weight by means of gel chromatography, of ≧20.000 g/mol and an average butyryl content of cellulose acetate butyrate of ≧20 wt. %, preferably ≧30 wt. %, and corresponding polymer foams.

The present invention relates to special expandable polymerizates or polymer granulates of cellulose acetate butyrate as well as corresponding polymeric foams of cellulose acetate butyrate.

Cellulose acetate butyrate (CAB) is a biopolymer based on cellulose. It is an ester of cellulose with aliphatic carboxylic acids. While in the case of cellulose acetate esterification is only with acetic acid, in the case of CAB esterification occurs with acetic acid and butyric acid.

Generally, cellulose acetate butyrate may be represented by the formula

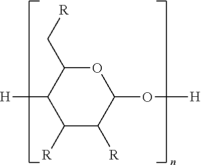

wherein each R within the polymer is independently selected from —OH (hydroxyl), —OOCCH₃ (acetate) and —OOCCH₂CH₂CH₃ (butyrate).

Compared to cellulose acetate and cellulose propionate, cellulose acetate butyrate has relatively low density as well as high strength, hardness and toughness. It is dimensionally stable within the temperature range of −45° C. to 115° C., has high temperature and UV resistance and is resistant to humidity and a plurality of chemicals and environmental factors.

Cellulose acetate butyrate has been on the market as an industrial plastic since 1946. In production, cellulose acetate butyrate is mainly used in granular form, which is useful for extrusion as well as injection molding.

Applications of cellulose acetate butyrate range from handle coatings, e.g. scales of Swiss Army knifes, to transparent domes, toys, cable conduits, coatings, and varnishes, for example, in the automotive and vehicle industries, for explosion-proof windows, vehicle lamps, automotive accessories, contact lenses, and office equipment, as well as foils and packaging materials or components of nail polishes and printing inks. Generally known trade names are Cellidor®, Tenite® and Tenex®.

The use of polymeric foams based on fossil raw materials such as EPS (expandable polystyrene) for packaging, insulation and a number of other applications has a longstanding tradition and is well established. Attempts in the past to replace the fossil raw materials with renewable raw materials were not successful. Poor mechanical and/or chemical properties conflicted with a broad use. Biological degradability offers great advantages for short-lived consumer goods. However, for long-lasting goods such as insulating boards it is a criterion for exclusion.

According to the state of the art, several applications for biopolymers are known:
U.S. Pat. No. 6,221,924 (“Biodegradable cellulose acetate foam and process for its production”) describes a method for producing foams of cellulose acetate having good mechanical properties. The molded articles made thereof are biologically degradable.
WO 2008/130226 (“Particulate expandable polylactic acid, a method for producing the same, a foamed molded product based on particulate expandable poly(lactic acid), as well as a method for producing the same”) describes a method for producing foams of poly(lactic acid) which also have good biological degradability.

There are several reasons why it is desirable to produce expandable polymer granulates from renewable raw materials.

Such expandable polymer granulates should be reliable and easy to process into foamed molded articles having good heat sealing, uniform cell structure with average cell sizes between 20 and 500 μm, and a density of 8 to 250 kg/m³. However, the polymer granulates should not be biologically degradable according to EN 13432: 2000 (requirements for packaging recoverable through composting and biodegradation).

In addition, the expandable polymer granulate should be processable in plants as they are usually used for processing expandable particle foams, e.g. EPS, in particular regarding commercial prefoamers, automatic presses, and block molds.

Further important criteria are the processing parameters during prefoaming, interim storage and sintering, which should be as similar as possible to those of EPS.

Furthermore, the foam parts made from the granulates described have to meet certain requirements regarding dimensional stability, e.g. postexpansion, shrinkage, cuttability with hot-wire and mechanical cutting systems.

Basically, it is possible to foam cellulose acetate butyrate or to process it into a particle foam. However, there are still no working production processes available that are suitable for industrial use and provide stable, advantageous foams.

It is thus an object of the invention to provide expandable polymerizates or polymer granulates consisting of cellulose acetate butyrate or a foam obtained therefrom, which have the above advantages and meet the above criteria.

This object is achieved by the features of claim 1.

According to the invention, it is intended that the expandable polymerizates consist of cellulose acetate butyrate having a number average molecular weight (Mn), as determined as the polystyrene-equivalent molecular weights by means of gel chromatography, of ≧20,000 g/mol and an average butyryl content of ≧20 wt %, preferably ≧30 wt %.

Experiments have surprisingly shown that it is important to stay within these limits in order to obtain granulates suitable for foaming or advantageous polymeric foams, respectively.

Therefore, n is selected so that the number average molecular weight Mn of the cellulose acetate butyrate polymer is at least 20,000 g/mol. Here, the number average molecular weight Mn is determined as the polystyrene-equivalent molecular weights by means of gel permeation chromatography in THF using polystyrene as standard.

The residues R in the polymer are selected from the group consisting of —OH (i.e. hydroxyl), —OOCCH₃ (i.e. acetate) and —OOCCH₂CH₂CH₃ (i.e. butyrate) so that the weight percentage of butyryl groups (i.e. —OCCH₂CH₂CH₃) on the CAB is higher than or equal to 20 wt %, preferably higher than or equal to 30 wt %. The reference for the indications in wt % is cellulose acetate butyrate itself, not the finished end product or the weight of the polymerizate that may include several additives.

Thus, cellulose acetate butyrate types having advantageous and suitable properties were found that could be processed into polymer granulates using the usual blowing agents in a process suitable for industrial purposes an that resulted in polymeric foam molded articles having the desired properties.

This leads to an expandable polymer granulate that shows especially good and reliable foamability and results in a dimensionally stable foam with an advantageous cell structure or size. Furthermore, the foam or granulate thus obtained has good sealability.

In addition, by following the inventive features, it is now possible to process the granulates in existing conventional plants, e.g. with prefoamers or automatic presses, because the material properties are comparable with the properties of EPS.

In addition, the polymeric foam obtainable from these granulates has high dimensional stability and may easily be cut into blocks or plates.

The terms “expandable polymerizates” and “expandable polymer granulates” relate to expandable particulate particles or CAB particles having a relatively small size, similar to commercial EPS beads. These particles may be stored and transported under standard conditions, and by accordingly selecting the processing parameters they may be foamed with various densities and then processed into molded parts. Furthermore, the particles may easily be expanded by increasing the temperature. It is possible to produce open-cell as well as closed-cell foams and all intermediate stages.

Advantageous embodiments or further developments of the invention are defined by the features of the dependent claims:
Especially preferred polymerizates or foams are obtained by providing a number average molecular weight Mn≧30,000 g/mol, in particular ≧40,000 g/mol. Preferably, the number average molecular weight is in the range of 30,000 to 70,000 g/mol.

An possible butyryl content is preferably in the range between 30 and 60 wt %.

Furthermore, it is advantageous to keep the weight percentage of the hydroxyl groups on the polymer at approximately 0.5 to approximately 2.5 wt %, preferably approximately 0.8 to approximately 1.8 wt,% on the CAB. Again, the reference for the wt % numbers is the cellulose acetate butyrate itself, not the weight of the polymerizates.

According to an advantageous further development of the invention, it is provided that the polymer has a glass temperature Tg in the range of 90° C. to 140° C.

In order to guarantee good and easy foamability, it is advantageous if a blowing agent is contained in the particles themselves or as a component of the particles, in particular pentane, preferably in a concentration of 3 to 10 wt %, based on the total weight of the polymer. Consequently, there is no need for a laborious impregnation with supercritical CO₂ under pressure. The CAB particles are ready to be processed and may be expanded any time without a further temperature increase.

In order to meet the necessary fire regulations, preferably at least one flame retardant may be contained. Depending on the purpose of use, the flame-retardant effect or environmental aspects, the flame retardant may be a halogenated organic compound, for example a bromine compound, preferably with a halogen content of at least 50 wt %.

Alternatively or in addition a halogenated or non-halogenated organic phosphorus compound, e.g. 9,10-dihydro-9-oxa-10-phosphaphenanthrene-10-oxide (DOP-O), 9,10-dihydro-9-oxa-10-phosphaphenanthrene-10-thione or -10-sulfide (DOP-S), triphenyl phosphate (TTP) etc., may be added.

Preferable amounts are, for example, 0.5 to 25 wt %, in particular 3 to 15 wt %, based on the total weight of the polymer. Optionally, a sulfur compound or elemental sulfur may be contained as synergists.

In this connection, it is especially preferable to provide for a flame retardant system consisting of a combination of at least one phosphorus compound as a flame retardant and at least one sulfur compound as an additional flame retardant or synergist. Here, the phosphorus compound is elemental phosphorus, in particular red phosphorus, at least one inorganic phosphorus compound, or hydrolyzates or salts thereof, and/or at least one organic phosphorus compound of the following general formula (I) or (II), or hydrolyzates or salts thereof,

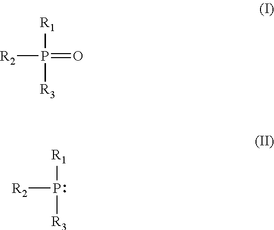

wherein the residues R₁, R₂ and R₃ independently represent organic or inorganic residues.

The sulfur compound is elemental sulfur and/or at least one inorganic or organic sulfur compound or sulfur-containing compound.

In order to achieve reduced thermal conductivity, it is advantageous if 1 to 10 wt %, based on the total weight of the polymer, of at least one infrared opacifier are contained, preferably selected from the group consisting of carbon black, metal oxides, metal powders and/or graphite.

Preferred polymerizates are characterized in that the individual grains have an average grain size of 0.2 to 5 mm and/or that the granulates are essentially spherical.

In order to prevent the polymerizates from sticking together, it may be provided that they have a coating layer, in particular one consisting of glycerol stearates, metal stearates, silicates, etc.

According to an advantageous further development of the invention, 0.05 to 3 wt % of a nucleation agent are contained, preferably one selected from the group consisting of polyolefine waxes, paraffins, Fischer-Tropsch waxes, the esters and amides of fatty acids, or inorganic particles having a grain size between 1 and 20 μm, or combinations thereof.

Below, an advantageous method for producing the above polymerizates is proposed, wherein the particles are granulated with the addition of a blowing agent by means of a pressurized under-water granulator at a pressure above 3 bar and a water temperature between 20 and 100° C.

In addition, an inventive polymeric foam is proposed which is formed of cellulose acetate butyrate and has a number average molecular weight (Mn), determined as polystyrene-equivalent molecular weights by means of gel chromatography, of ≧20,000 g/mol, as well as an average butyryl content of ≧20 wt %, preferably ≧30 wt %.

The foam may be an open-cell, closed-cell or mixed foam.

Preferred are number average molecular weights (Mn) of ≧30,000 g/mol, in particular ≧40,000 g/mol, preferably in the range between 30,000 and 70,000 g/mol.

A possible advantageous butyryl content is in the range between 30 and 60 wt %.

This foam has the advantages as mentioned above, i.e. good dimensional stability, easy processability, cuttability, etc., and is preferably used for foam molded articles for packaging, insulating materials, technical materials, safety helmets, insulating boards, etc.

The polymeric foam may be produced by extrusion. An alternative preferred method consists in forming the polymeric foam as a particle foam. Here, the expandable polymerizates described above are further processed by means of conventional methods, especially by foaming and sintering the particles, to obtain the foam.

In this connection, it is preferred if the foam has a uniform cell structure with cell sizes between 20 and 500 μm.

According to a further embodiment of the invention it is envisaged that the foam has a density of 8 to 250 kg/m³.

In order to allow the use of long-lasting products such as insulating boards, it is preferred to provide a foam that is not biologically degradable according to EN 13432:2000.

An especially preferred embodiment of the polymeric foam provides for particles containing an infrared opacifier and particles without infrared opacifier being sintered together in a regular or irregular distribution. Such a foam has low thermal conductivity, combined with high dimensional stability, especially in the case of insulation.

Below, the invention will be shown by means of a few especially preferred embodiments:

### EXAMPLES

### Example 1

A cellulose acetate butyrate (chain length Mn=30,000 g/mol, butyryl content=38 wt %, 1.3 wt % hydroxyl groups) was molten in a twin-screw extruder, and 6 wt % of pentane were added to the melt. The polymer melt thus obtained was transported through a die plate with a throughput of 20 kg/h and granulated by means of a pressurized underwater granulator to obtain compact polymer granulates.

### Example 2

A cellulose acetate butyrate (chain length Mn=30,000 g/mol, butyryl content=55 wt %, 1.8 wt % hydroxyl groups) was molten in a twin-screw extruder, and 6 wt % of pentane were added to the melt. The polymer melt thus obtained was transported through a die plate with a throughput of 20 kg/h and granulated by means of a pressurized underwater granulator to obtain compact polymer granulates.

### Example 3

A cellulose acetate butyrate (chain length Mn=16,000 g/mol, butyryl content=55 wt %, 1.5 wt % hydroxyl groups) was molten in a twin-screw extruder, and 6 wt % of pentane were added to the melt. The polymer melt thus obtained was transported through a die plate with a throughput of 20 kg/h and granulated by means of a pressurized underwater granulator to obtain compact polymer granulates.

### Example 4

A cellulose acetate butyrate (chain length Mn=67,000 g/mol, butyryl content=38 wt %, 0.8 wt % hydroxyl groups) was molten in a twin-screw extruder, and 6 wt % of pentane were added to the melt. The polymer melt thus obtained was transported through a die plate with a throughput of 20 kg/h and granulated by means of a pressurized underwater granulator to obtain compact polymer granulates.

### Example 5

A cellulose acetate butyrate (chain length Mn=67,000 g/mol, butyryl content=17 wt %, 1.1 wt % hydroxyl groups) was molten in a twin-screw extruder, and 6 wt % of pentane were added to the melt. The polymer melt thus obtained was transported through a die plate with a throughput of 20 kg/h and granulated by means of a pressurized underwater granulator to obtain compact polymer granulates.

### Example 6

A cellulose acetate butyrate (chain length Mn=20,000 g/mol, butyryl content=55 wt %, 1.6 wt % hydroxyl groups) was molten in a twin-screw extruder, and 6 wt % of pentane were added to the melt. The polymer melt thus obtained was transported through a die plate with a throughput of 20 kg/h and granulated by means of a pressurized underwater granulator to obtain compact polymer granulates.

### Example 7

Example 1 was repeated with the difference that additionally 0.25 wt % of Polwax 2000 (Baker Hughes) were added as nucleation agent.

### Example 8

Example 2 was repeated with the difference that additionally 0.25 wt % of Polwax 2000 (Baker Hughes) were added as nucleation agent.

### Example 9

Example 1 was repeated with the difference that additionally 2.5 wt % of hexabromocyclododecane were added.

### Example 10

Example 2 was repeated with the difference that additionally 10 wt % of 9,10-dihydro-9-oxa-10-phosphaphenantrene-10-oxide (DOPO) and 3 wt % of 2,2′-dithiobis(benzothiazole) were added.

### Example 11

Example 1 was repeated with the difference that additionally 2 wt % of crystalline natural graphite (d₉₀<12 μm) and 2.5% of hexabromocyclododecane were added.

### Example 12

Example 1 was repeated with the difference that additionally 2.5 wt % of carbon black (Evonik Printex L6) and 2.5% of hexabromocyclododecane were added.

The polymer granulates obtained in examples 1 to 12 were prefoamed to the smallest possible bulk density by means of a pressurized prefoamer (Kurtz X1.5). After interim storage for 18 hours, sheets with approximately 30×30×5 cm were produced in a automatic press (Erlenbach C87/67/1).

### Results:

| Results | Minimum density | average | B2 small burner |
|---|---|---|---|
| of the | obtainable with one | cell size | test according |
| examples | foaming step [kg/m³] | [μm] | to DIN4102-2 |
| Example 1 | 20 | 200 | not passed |
| Example 2 | 19 | 200 | not passed |
| Example 3 | — (collapsed) | — | — |
| Example 4 | 19 | 200 | not passed |
| Example 5 | — (not expandable) | — | — |
| Example 6 | 30 (after collapse) | 250 | not passed |
| Example 7 | 20 | 100 | not passed |
| Example 8 | 18 | 90 | not passed |
| Example 9 | 21 | 180 | passed |
| Example 10 | 26 | 250 | passed |
| Example 11 | 21 | 100 | passed |
| Example 12 | 25 | 190 | passed |

Experiments 3 and 5, where CAB types with a molecular weight of 65,000 g/mol and a butyryl content of 17 wt % or with a molecular weight of 16,000 g/mol and a butyryl content of 55 wt % were used, could not be processed with any machines commonly used for EPS processing. The granulate from Experiment 3 collapsed right after the steam treatment in the prefoamer and could not be processed further. The granulate from Example 5 could not be prefoamed to a density lower than 250 kg/m³, even with maximum steam treatment.

The granulate of Experiment 6 with CAB with a molecular weight of 20,000 g/mol and a butyryl content of 55 wt % could be prefoamed to acceptable bulk densities, even though the prefoamed granulate clearly collapsed during interim storage.

A comparison of Examples 3, 6 and 2—in this order—, where polymerizates with a butyryl content of 55 wt % and increasing chain lengths, shows that a chain length of 16,000 g/mol did not provide a foamable granulate, and that with 30,000 g/mol a satisfactory result was achieved. With a chain length of 20,000 g/mol (Example 6) prefoaming barely resulted in an acceptable bulk density, which is why the lower limit was set at this value.

In Examples 4 and 5, polymerizates with identical chain lengths but different butyryl contents were compared. It is shown that granulates with a butyryl content of 17 wt % could not be prefoamed to an acceptable bulk density, while the polymerizate with a butyryl content of 38 wt % led to a good result. Therefore, the lower limit for the butyryl content was set at 20 or 30 wt %.

The polymerizates of Examples 7 and 8 gave foams with small average cell sizes between 90 and 100 μm.

In Examples 9 to 12 different flame retardants were added. The granulates from Examples 9, 11 and 12 with a content of 2.5 wt % of HBCD and from Example 10 with 10 wt % of DOPO and 3 wt % of 2,2′-dithiobis(benzothiazole) met the criteria of the B2 small burner test according to DIN 4102-2. It has been shown that satisfactory results and stable foams were obtained despite the flame retardant.

1. Expandable particulate polymerizates or polymer granulates containing at least one blowing agent and being made of cellulose acetate butyrate (CAB) having a number average molecular weight (Mn), as determined as polystyrene-equivalent molecular weights by means of gel chromatography, of ≧20,000 g/mol and an average butyryl content of ≧20 wt %, preferably ≧30 wt %.

2. Expandable polymerizates according to claim 1, characterized in that the number average molecular weight (Mn) of ≧30,000 g/mol, in particular ≧40,000 g/mol, is in the range of 30,000 to 70,000 g/mol and/or that the average butyryl content is between 30 and 60 wt %.

3. Expandable polymerizates according to claim 1, characterized in that the weight percentage of the hydroxyl groups on the cellulose acetate butyrate is approximately 0.5 to approximately 2.5 wt %, preferably approximately 0.8 to approximately 1.8 wt %.

4. Expandable polymerizates according to claim 1, characterized in that the polymer has a glass temperature Tg in the range of 90° C. to 140° C.

5. Expandable polymerizates according to claim 1, characterized in that the blowing agent(s), in particular pentane, is/are contained in a concentration of 3 to 10 wt %, based on the total weight of the polymer.

6. Expandable polymerizates according to claim 1, characterized in that they contain at least one flame retardant, in particular a halogenated organic compound, for example a bromine compound, preferably one having a halogen content of at least 50 wt %, and/or a halogenated or non-halogenated organic phosphorus compound, e.g. 9,10-dihydro-9-oxa-10-phosphaphenanthrene-10-oxide (DOP-O), 9,10-dihydro-9-oxa-10-phosphaphenanthrene-10-thione or -10-sulfide (DOP-S), triphenyl phosphate (TTP) etc., particularly in an amount of 0.5 to 25 wt %, most preferably 3 to 15 wt %, as well as optionally a sulfur compound or elemental sulfur as a synergist.

7. Expandable polymerizates according to claim 6, characterized in that a combination of at least one phosphorus compound as a flame retardant and at least one sulfur compound as an additional flame retardant oder synergist is contained as a flame retardant system, wherein:
a) the phosphorus compound is
elemental phosphor, particularly red phosphorus,
at least one inorganic phosphorus compound, or hydrolyzates or salts thereof, and/or
at least one organic phosphorus compound of the following general formula (I) or (II), or hydrolyzates or salts thereof, 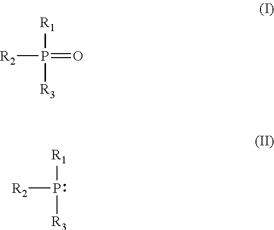
wherein the residues R₁, R₂ and R₃ independently represent organic or inorganic residues, and wherein
b) the sulfur compound is
elemental sulfur and/or
at least one inorganic or organic sulfur compound or sulfur-containing compound.

8. Expandable polymerizates according to claim 1, characterized in that 1 to 10 wt %, based on the total weight of the polymer, of at least one infrared opacifier are contained, preferably selected from the group consisting of carbon black, metal oxides, metal powders, and/or graphite.

9. Expandable polymerizates according to claim 1, characterized in that the individual grains have an average grain size of 0.2 to 5 mm and/or that the granulates are essentially spherical.

10. Expandable polymerizates according to claim 1, characterized in that they have a coating layer, in particular one consisting of glycerol stearates, metal stearates, silicates, etc.

11. Expandable polymerizates according to claim 1, characterized in that they contain 0.05 to 3 wt % of a nucleation agent, preferably one selected from the group consisting of polyolefin waxes, paraffins, Fischer-Tropsch waxes, esters and amides of fatty acids, or inorganic particles having a grain size between 1 and 20 μm, or combinations thereof.

12. A method for producing expandable polymerizates of cellulose acetate butyrate according to claim 1 with the addition of a blowing agent, wherein granulation of the particles is achieved by means of a pressurized underwater granulator at a pressure above 3 bar and a water temperature between 20 and 100° C.

13. A polymeric foam in the form of a particle foam, in particular foam parts for packaging, insulating materials, technical materials, safety helmets, insulating boards, etc., made of cellulose acetate butyrate having a number average molecular weight (Mn), determined as polystyrene-equivalent molecular weights by means of gel chromatography, of ≧20,000 g/mol, preferably ≧30,000 g/mol, most preferably ≧40,000 g/mol, preferably in a range between 30,000 and 70,000 g/mol, as well as an average butyryl content on the cellulose acetate butyrate of ≧20 wt %, preferably ≧30 wt %, optionally between 30 and 60 wt %, optionally obtained by extrusion.

14. A polymeric foam in the form of a particle foam obtainable from expandable polymerizates according to claim 1, especially by foaming and sintering the polymerizates.

15. A polymeric foam according to claim 13, characterized in that it has a uniform cell structure with average cell sizes between 20 and 500 μm.

16. A polymeric foam according to claim 13, characterized in that it has a density of 8 to 250 kg/m³.

17. A polymeric foam according to claim 13, characterized in that it is biologically non-degradable according to EN 13432:2000.

18. A polymeric foam according to claim 13, characterized in that particles containing an infrared opacifier and particles without infrared opacifier are sintered together in a regular or irregular distribution.

19. A polymeric foam in the form of a particle foam obtainable from the expandable polymerizates according to claim 1, characterized in that particles containing an infrared opacifier and particles without infrared opacifier are sintered together in a regular or irregular distribution.
